(19) United States
(12) Patent Application Publication
(10) Pub. No.: US 2018/0139491 A1
(43) Pub. Date: May 17, 2018

(54) REPRODUCTION DEVICE, DELIVERY DEVICE, REPRODUCTION METHOD, AND DELIVERY METHOD

(71) Applicant: SHARP KABUSHIKI KAISHA, Sakai City, Osaka (JP)

(72) Inventors: SHUHICHI WATANABE, Sakai City (JP); TAKUYA IWANAMI, Sakai City (JP)

(21) Appl. No.: 15/579,174

(22) PCT Filed: May 19, 2016
(86) PCT No.: PCT/JP2016/064928

§ 371 Date: Dec. 1, 2017

(30) Foreign Application Priority Data
Jun. 4, 2015 (JP) 2015-114074

(51) Int. Cl. H04N 21/435; H04N 21/462; H04N 21/845; H04N 21/44; H04N 21/439

(52) U.S. Cl. CPC H04N 21/435; H04N 21/462; H04N 21/4884; H04N 21/44; H04N 21/439; H04N 21/8456

(57) ABSTRACT

A data broadcasting processor (230) of a television receiver (200) obtains carousel data and an event message. The processor (230) reproduces each data component of the carousel data in a regular condition. During a period indicated by reproduction period information in the event message, the processor (230) reproduces a data component that includes information of higher value and that is included in the event message, instead of one of the data components which are being reproduced.

### TECHNICAL FIELD

The present invention relates mainly to a delivery device and a reproduction device. The delivery device delivers the same data content periodically. The reproduction device reproduces the data content delivered by the delivery device.

### BACKGROUND ART

Various techniques related to data broadcasting have been proposed.

PTL 1 discloses a technique in which, in a data broadcasting system which repeatedly transmits data constituted by multiple components, the multiple components are transmitted at different frequencies depending on the components.

PTL 2 and PTL 3 disclose techniques of performing data broadcasting by using a carousel method and a non-carousel method together.

### CITATION LIST

### Patent Literature

PTL 1: Japanese Unexamined Patent Application Publication No. 11-346198 (published Dec. 14, 1999)

PTL 2: Japanese Unexamined Patent Application Publication No. 2001-144703 (published May 25, 2001)

PTL 3: Japanese Unexamined Patent Application Publication No. 2001-54077 (published Feb. 23, 2001)

### SUMMARY OF INVENTION

### Technical Problem

A user of a receiver, which uses the technique in PTL 1 to receive data content delivered along with a program, obtains the same information through data broadcasting regardless of a period during which the program is viewed.

In contrast, a user of a receiver, which uses the technique in PTL 2 or 3 to receive data content delivered along with a program, obtains, through data broadcasting, information in accordance with a period during which the program is viewed. Specifically, in addition to information delivered by using a carousel method, the user obtains information delivered by using a non-carousel method during the period.

In other words, for example, a person who delivers a program by using the technique in PTL 3 may cause only certain users to obtain information indicated by the specific data K if the certain users are viewing the program when specific data K is delivered by using a non-carousel method.

However, even when the person who delivers the program wants specific viewers who continue viewing the program over a certain length of time, to obtain particular information through data broadcasting in order to improve the rating of the program, it is not possible to achieve such a desire by using the techniques in PTLs 1 to 3.

The present invention has been made in view of the above-described issue, and its main object is to implement a reproduction device and a delivery device which enable specific viewers who continue viewing a program over a certain length of time, to obtain particular information of higher value.

### Solution to Problem

To address the above-described issue, a reproduction device according to an aspect of the present invention includes an acquisition processor and a reproduction processor. The acquisition processor acquires first data content, second data content, and information. The first data content is delivered periodically by broadcasting. The second data content is delivered nonperiodically by broadcasting or communication. The information is delivered nonperiodically by broadcasting. The reproduction processor reproduces the first data content. The information indicates a reproduction period during which the second data content is to be reproduced. In the case where the acquisition processor acquires the information and the second data content, the reproduction processor reproduces the second data content during the reproduction period in such a manner that a user is capable of recognizing the second data content instead of the first data content.

To address the above-described issue, a delivery device according to an aspect of the present invention includes a first delivery processor and a second delivery processor. The first delivery processor delivers first data content periodically by broadcasting. The second delivery processor delivers information nonperiodically by broadcasting. The information indicates a reproduction period during which second data content is to be reproduced by a reproduction device in such a manner that a user is capable of recognizing the second data content instead of the first data content.

### Advantageous Effects of Invention

The reproduction device and the delivery device according to the aspects of the present invention have an effect that specific viewers who continue viewing a program over a certain length of time may obtain particular information of higher value.

### BRIEF DESCRIPTION OF DRAWINGS

FIG. 1 is a block diagram illustrating the configuration of principal parts of a broadcasting device and a television receiver according to a first embodiment of the present invention.

FIG. 2 is a flowchart of operations related to reproduction of data content which is performed by the television receiver according to the first embodiment.

FIG. 3 is a conceptual diagram illustrating an exemplary operation related to reproduction of data content which is performed by the television receiver according to the first embodiment.

FIG. 4 is a conceptual diagram illustrating another exemplary operation related to reproduction of data content which is performed by the television receiver according to the first embodiment.

FIG. 5 is a conceptual diagram illustrating yet another exemplary operation related to reproduction of data content which is performed by the television receiver according to the first embodiment.

FIG. 6 is a conceptual diagram illustrating another exemplary operation related to reproduction of data content which is performed by the television receiver according to the first embodiment.

FIG. 7 is a block diagram illustrating the configuration of principal parts of a broadcasting device, a server, and a television receiver according to a second embodiment of the present invention.

FIG. 8 is a flowchart of operations related to reproduction of data content which is performed by the television receiver according to the second embodiment.

FIG. 9 is a conceptual diagram illustrating an exemplary operation related to reproduction of data content which is performed by the television receiver according to the second embodiment.

### DESCRIPTION OF EMBODIMENTS

### First Embodiment

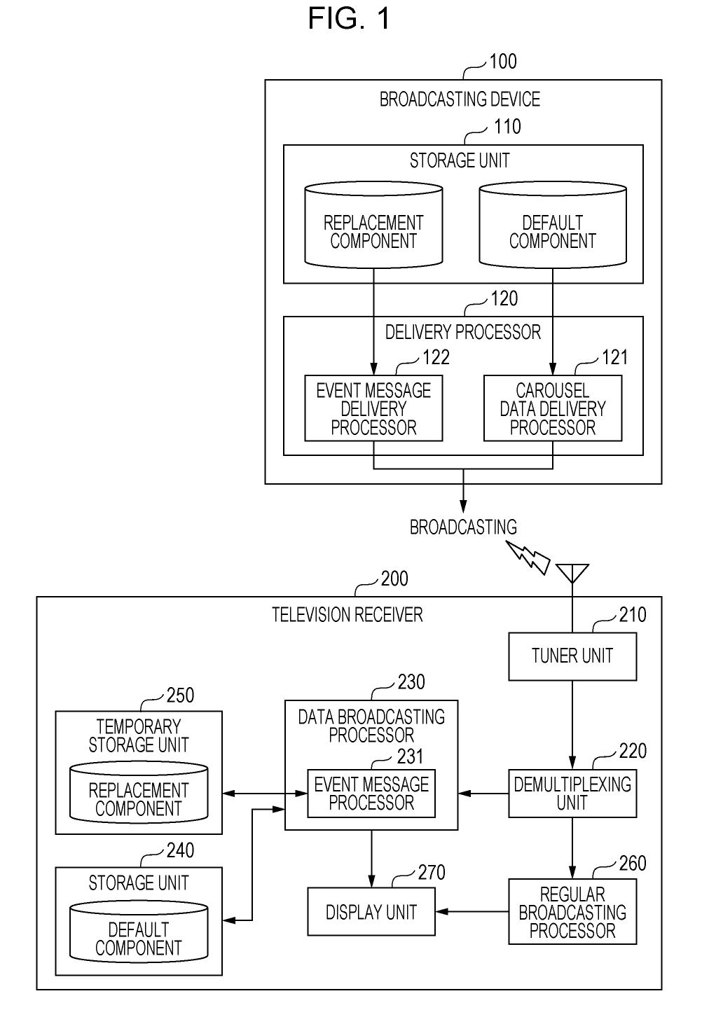

A broadcasting device and a television receiver included in a system according to an embodiment of the present invention will be described in detail below with reference to FIGS. 1 to 7.

(Overview and Configuration of the Broadcasting Device and the Television Receiver)

The overview and configuration of the broadcasting device and the television receiver will be described with reference to FIG. 1. FIG. 1 is a block diagram illustrating the configuration of principal parts of the broadcasting device and the television receiver.

A broadcasting device 100 is a device that delivers data content (specifically, data broadcasting content) in addition to video content, audio content, and subtitles content which constitute a program.

Data content in the specification is content that is delivered by broadcasting or communication and that is presented by a receiver along with a video, audio, and/or subtitles which constitute a program. In the specification, a component included in data content (a data component, for example, data, such as an application and an image, used in presentation of a data broadcasting screen) is also included in the concept of data content.

A television receiver 200 is a device that reproduces data content in addition to a video, audio, and subtitles which constitute a program.

A system according to the present embodiment is characterized by a method, which is performed by the broadcasting device 100, for delivering data content, and a method, which is performed by the television receiver 200, for reproducing data content. These characteristics will be described in detail below.

As illustrated in FIG. 1, the broadcasting device 100 includes a storage unit 110 and a delivery processor 120.

The storage unit 110 is a recording medium in which video content, audio content, subtitles content, and data content are recorded.

The delivery processor 120 is a processor that delivers a digital broadcast signal by multiplexing video content, audio content, subtitles content, and data content.

The delivery processor 120 functions as a carousel data delivery processor 121 and an event message delivery processor 122.

The broadcasting device 100 (or the delivery processor 120 of the broadcasting device 100) also includes a regular-broadcasting delivery processor for appropriately delivering video content, audio content, and subtitles content which are related to regular broadcasting, and also includes a multiplexing unit for appropriately multiplexing, for delivery, video content, audio content, and subtitles content for regular broadcasting and data content for data broadcasting. However, these are not characteristic components in the present invention, and are not particularly illustrated in FIG. 1.

The carousel data delivery processor 121 delivers carousel data including data components (default components) that are to be displayed by the television receiver 200 by default by using a carousel method (that is, periodically). The carousel data means data transmitted by using a carousel method.

The event message delivery processor 122 nonperiodically delivers an event message including a data component (replacement component) that is to be displayed by the television receiver 200 by replacing one of the default components with the data component. The event message includes information (reproduction period information) indicating a reproduction period during which the television receiver 200 is to reproduce the replacement component so that a user may view (recognize) the replacement component instead of one of the default components. Specifically, the replacement component and the reproduction period information are included in the private data area of an event message.

As illustrated in FIG. 1, the television receiver 200 includes a tuner unit 210, a demultiplexing unit 220, a data broadcasting processor 230, a storage unit 240, a temporary storage unit 250, a regular broadcasting processor 260, and a display unit 270.

The tuner unit 210 is a tuner that receives a digital broadcast signal.

The demultiplexing unit 220 performs demultiplexing processing on the digital broadcast signal so as to obtain video content, audio content, subtitles content, and data content.

The data broadcasting processor 230 is a processor that performs processing for presenting data content.

Specifically, the data broadcasting processor 230 obtains carousel data that is delivered by broadcasting periodically and that includes default components, and displays the obtained default components on the data broadcasting screen of the display unit 270.

The data broadcasting processor 230 functions as an event message processor 231.

The event message processor 231 obtains an event message that is delivered by broadcasting nonperiodically and that includes a replacement component and reproduction period information indicating a reproduction period during which the replacement component is to be reproduced.

When the event message processor 231 obtains an event message, the event message processor 231 records, in the temporary storage unit 250, the replacement component included in the event message until the end of the reproduction period indicated in the event message.

When the reproduction period indicated in the event message starts, the event message processor 231 deletes one of the default components from the screen. Over the reproduction period, the event message processor 231 displays the replacement component at a position at which the default component has been displayed. Instead of deleting the default component from the screen, the event message processor 231 may display the replacement component at the display position of the default component so that the replacement component covers the default component. Thus, the default component is deleted apparently.

The storage unit 240 is a recording medium in which default components are recorded.

The temporary storage unit 250 is a recording medium in which replacement components are recorded.

The regular broadcasting processor 260 is a processor that performs processing for presenting video content, audio content, and subtitles content.

The display unit 270 is a display on which video content, subtitles content, and data content are displayed.

The data broadcasting processor 230 and the regular broadcasting processor 260 may be implemented by using a single processor. Alternatively, the demultiplexing unit 220, the data broadcasting processor 230, and the regular broadcasting processor 260 may be implemented by using a single processor.

The television receiver 200 may include, instead of the storage unit 240 and the temporary storage unit 250, a recording medium in which default components and replacement components are recorded.

(Operations of the Television Receiver 200)

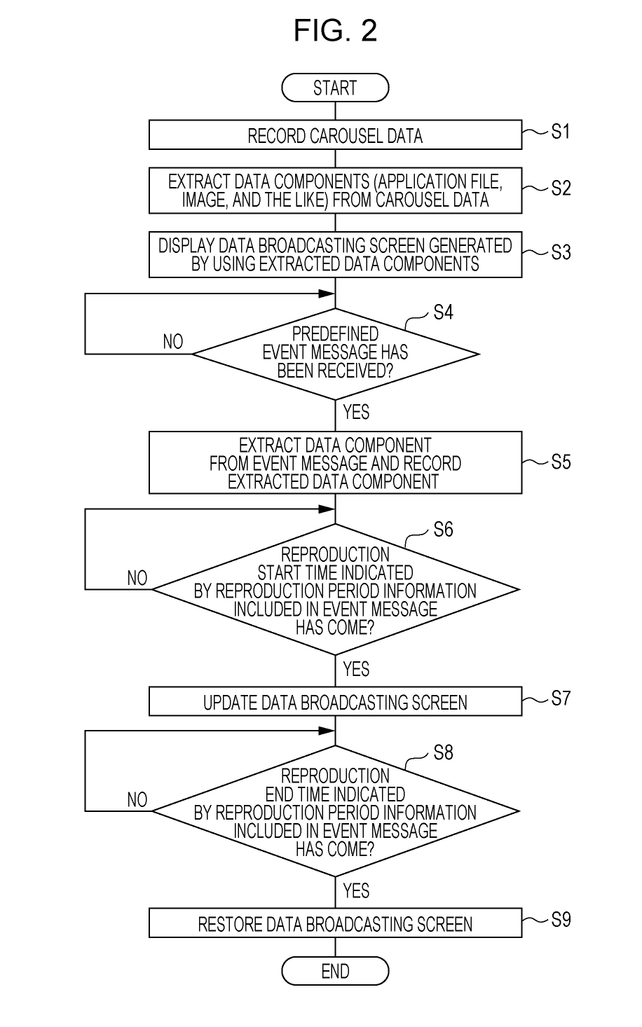

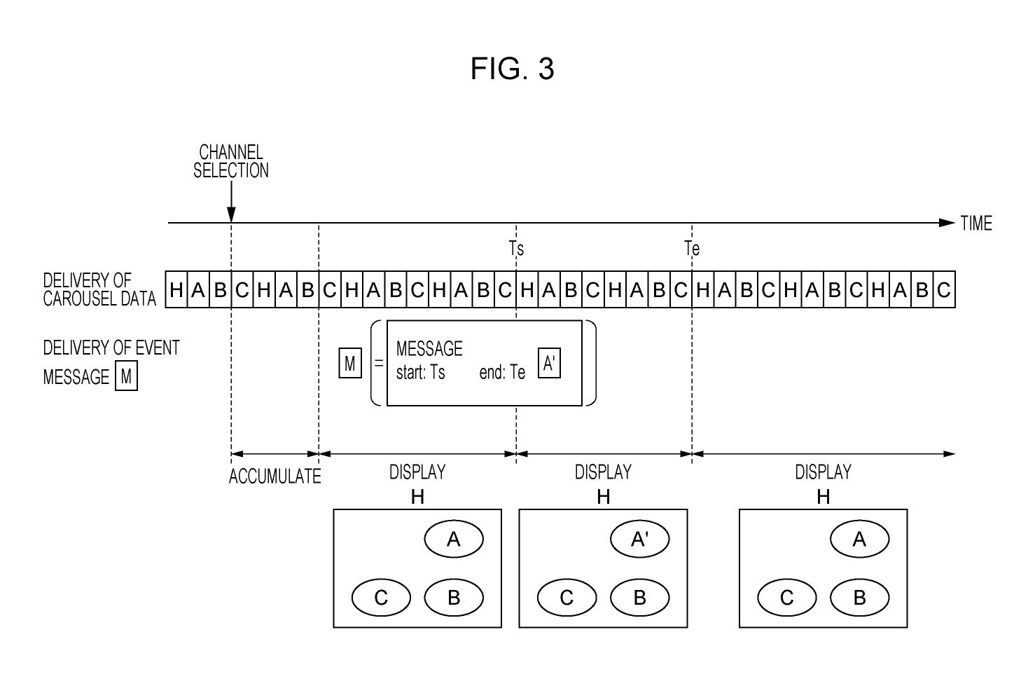

Operations related to reproduction of data content which is performed by the television receiver 200 will be described with reference to FIGS. 2 to 6. FIG. 2 is a flowchart of the operations. FIGS. 3 to 6 are conceptual diagrams illustrating exemplary operations related to reproduction of data content which is performed by the television receiver 200.

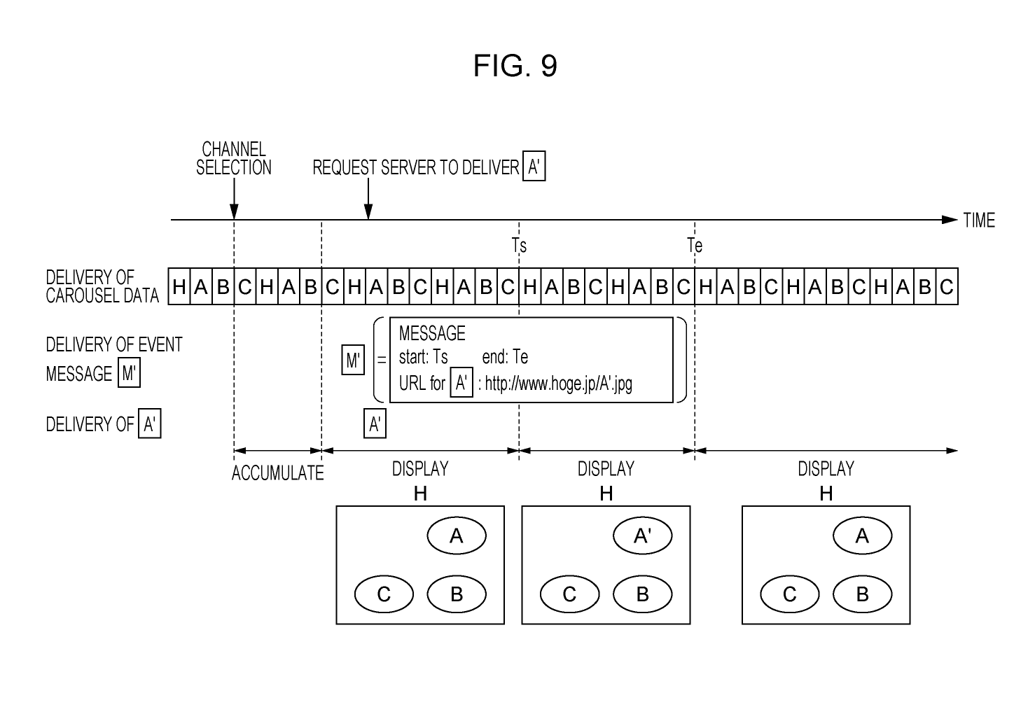

Four data components (data components H, A, B, and C) in FIGS. 3 to 6 are default components. Data including these four data components is carousel data. Data component H is an application (a structured document (for example, a document of HTML5, BML, or the like) indicating a display period for the application and display positions of texts, still images, and the like). The remaining three data components (data components A, B, and C) are components (a text, a still image, a moving picture, and the like) invoked by the application data component. The same is true for FIG. 9 referred to in a second embodiment.

Upon completion of a channel selection operation, the television receiver 200 (a part constituted by the tuner unit 210 and the demultiplexing unit 220) receives carousel data along with video data, audio data, and subtitles data which constitute a program broadcasted by the broadcasting device 100. The demultiplexing unit 220 supplies the regular broadcasting processor 260 with the video data, the audio data, and the subtitles data which constitute the program, and supplies the data broadcasting processor 230 with the carousel data.

As illustrated in FIG. 2, the data broadcasting processor 230 records, in the storage unit 240, carousel data supplied from the demultiplexing unit 220 (S1).

After S1, the data broadcasting processor 230 extracts the data components from the carousel data (S2), generates a data broadcasting screen by using the extracted data components, and displays the generated data broadcasting screen on the display unit 270 (S3). Each of the data components includes an ID unique to the default component.

After S3, during displaying the data broadcasting screen, the data broadcasting processor 230 repeatedly performs a step (S4) in which it is determined whether or not a predefined event message M has been received, until the predefined event message M is received.

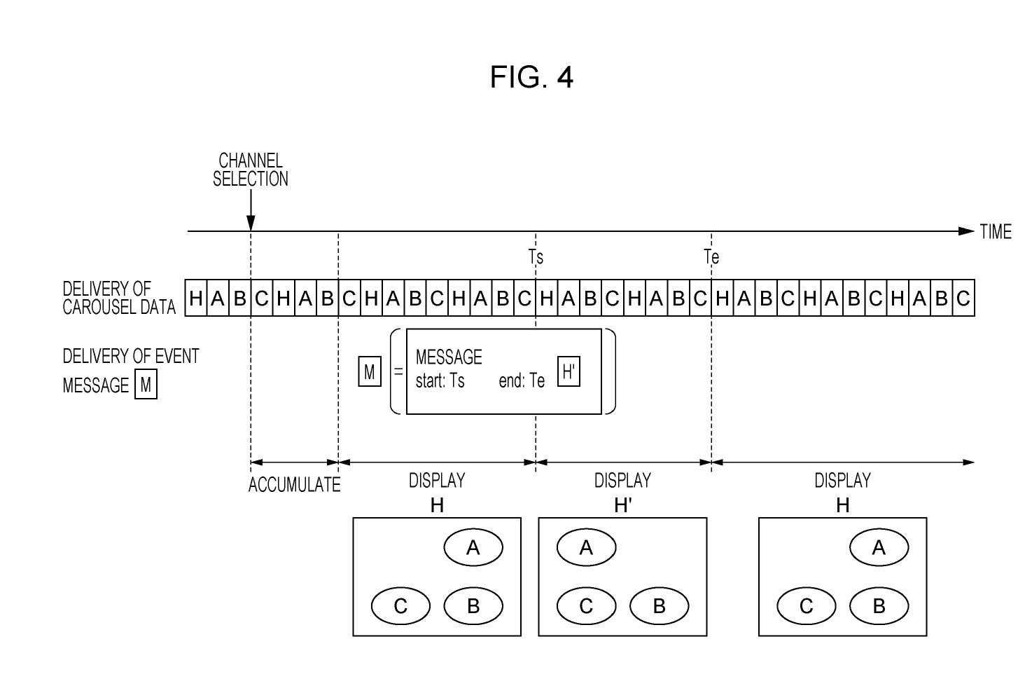

If the data broadcasting processor 230 has received a predefined event message M (YES in S4), the event message processor 231 extracts a replacement component from the predefined event message M, and records the extracted replacement component (for example, data component A′ in FIG. 3 or data component H′ in FIG. 4) in the temporary storage unit 250 (S5). The replacement component includes the ID of a default component (for example, data component A in FIG. 3 or data component H in FIG. 4) that is to be replaced with the replacement component.

After S5, the event message processor 231 refers to reproduction period information included in the predefined event message M. The event message processor 231 repeatedly performs a step (S6) in which it is determined whether or not a reproduction start time (for example, time Tₛ in FIGS. 3 and 4) indicated by the reproduction period information has come, until the reproduction start time comes.

If the event message processor 231 determines that the reproduction start time has come (YES in S6), the data broadcasting processor 230 updates the data broadcasting screen (S7).

Specifically, the data broadcasting processor 230 specifies the default component having the same ID as the ID included in the replacement component, and starts reproduction of the replacement component so that a user may view the replacement component (second data content) instead of the specified default component (first data content).

For example, the case in which the replacement component is data component A′ and in which the specified data component is data component A will be described. In this case, as illustrated in FIG. 3, the data broadcasting processor 230 displays, as a mask, data component A′ (particular image) in a region in which data component A has been displayed, in such a manner that data component A (regular image) is hidden. Thus, the data broadcasting processor 230 updates the data broadcasting screen.

For example, the case in which the replacement component is data component H′ and in which the specified data component is data component H will be described. In this case, the data broadcasting processor 230 stops reproduction of data component H (a structured document). Then, the data broadcasting processor 230 newly reproduces data component H′ (a structured document in which only information about a tag indicating the display position of data component A is different from that of data component H). Thus, the data broadcasting processor 230 updates the data broadcasting screen.

After S7, the event message processor 231 repeatedly performs a step (S8) in which it is determined whether or not a reproduction end time (for example, time Tₑ in FIGS. 3 and 4) indicated by the reproduction period information has come, until the reproduction end time comes.

If the event message processor 231 determines that the reproduction end time has come (YES in S8), the data broadcasting processor 230 restores the data broadcasting screen (S9).

For example, the case in which the replacement component is data component A′ and in which the specified data component is data component A will be described. In this case, as illustrated in FIG. 3, the data broadcasting processor 230 stops reproduction of data component A′ (that is, ends the mask display of data component A′), thereby restoring the data broadcasting screen.

For example, the case in which the replacement component is data component H′ and in which the specified data component is data component H will be described. In this case, the data broadcasting processor 230 stops reproduction of data component H′. Then, the data broadcasting processor 230 reproduces data component H again, thereby restoring the data broadcasting screen.

In the case where the replacement component is data component A′, during reproduction of data component A′, the data broadcasting processor 230 may continue reproduction of data component A or may stop reproduction of data component A.

The operations of the television receiver 200 are described above.

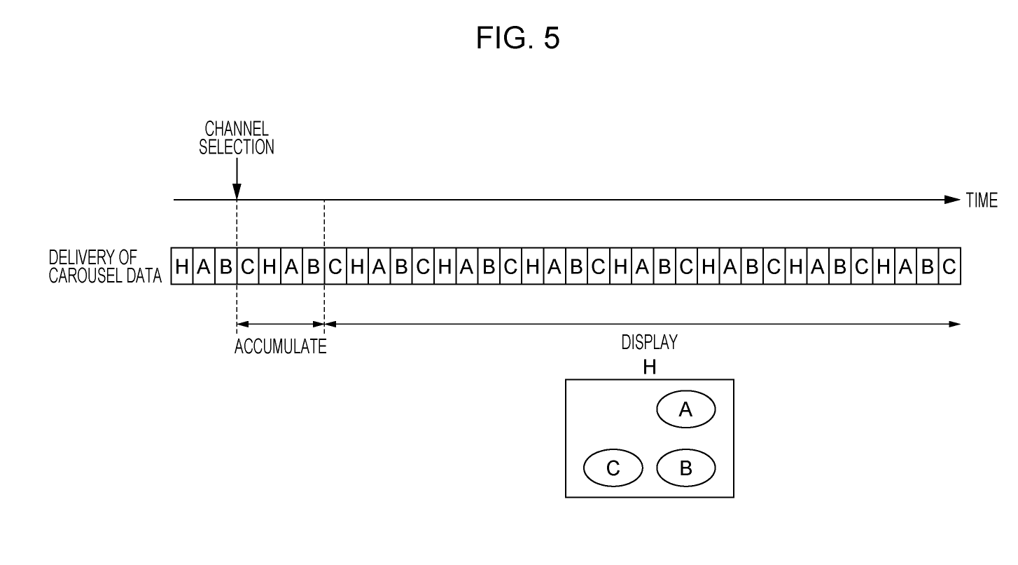

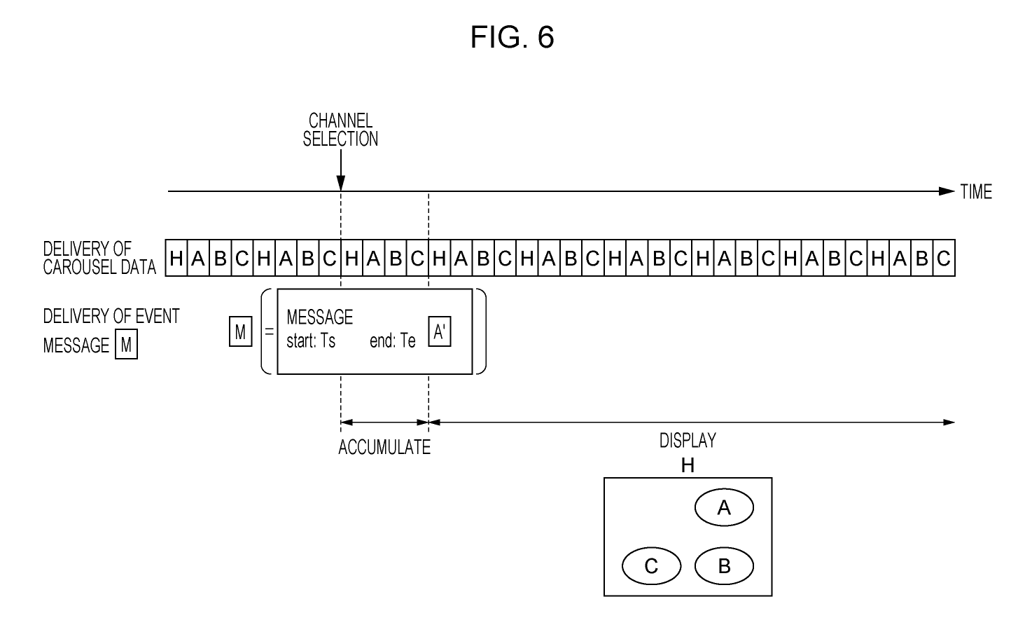

As seen from the description above and FIGS. 5 and 6, in the case where the broadcasting device 100 delivers no event messages M during delivery of a program, or where, after the broadcasting device 100 delivers an event message M, a channel selection operation for reproducing a program is performed on the television receiver 200, the television receiver 200 does not update the data broadcasting screen as illustrated in FIGS. 3 and 4.

(First Additional Matter)

Regardless of whether or not the replacement component is an application data component, the television receiver 200 according to the present embodiment updates the data broadcasting screen in step S7 as described above. However, the present invention is not limited to such a configuration. That is, only when the replacement component is an application data component, the television receiver 200 may update the data broadcasting screen in step S7 as described above. Alternatively, only when the replacement component is not an application data component, the television receiver 200 may update the data broadcasting screen in step S7 as described above.

(Second Additional Matter)

A replacement component and a data component replaced with the replacement component may be audio components. That is, the television receiver 200 may output, by audio, particular valuable information by reproducing the replacement component during the reproduction period indicated by the event message M, and may output, by audio, regular information by reproducing the data components during a period other than the reproduction period.

When the replacement component is auxiliary/additional audio information such as audio commentary, the television receiver 200 may reproduce the replacement component and the replaced data component at the same time, and may output the combined audio. Further, when the replacement component and the replaced data component are audio components, the television receiver 200 may output the audio adjusted so that the sound source is located at the screen display position indicated by the application.

(Third Additional Matter)

As long as the replacement component includes any information available in specifying a data component that is to be replaced with the replacement component, any replacement component may be used. For example, information included in the replacement component may be, not the ID of a data component that is to be replaced with the replacement component, an identifier describing the ID (an identifier indicating the ID and any information other than the ID (for example, the type of the data component)).

(Fourth Additional Matter)

For example, the television receiver 200 may be provided with a person detection sensor. In this case, the television receiver 200 may accumulate information indicating a state in which a user of the television receiver 200 views the program (information indicating a period during which the person detection sensor detects the user of the television receiver 200), in the storage unit 240 during reproduction of the program.

During delivery of the latter half of the program, the broadcasting device 100 may deliver an event message including the replacement component, the reproduction period information, and viewing condition information. That is, the broadcasting device 100 may deliver an event message including the viewing condition information indicating that only a viewer who has continued viewing the first half of the program has permission to view the replacement component.

When the data broadcasting processor 230 receives an event message including the viewing condition information at S4, the data broadcasting processor 230 may refer to information indicating the program viewing state. Thus, the data broadcasting processor 230 may determine whether or not the user of the television receiver 200 has continued viewing the first half of the program. Only if the data broadcasting processor 230 determines that the user of the television receiver 200 has continued viewing the first half of the program, the data broadcasting processor 230 may perform processes in S5 and its subsequent steps.

(Fifth Additional Matter)

Each default component included in carousel data delivered by the broadcasting device 100 may include information indicating the significance of the default component.

For a default component having a significance equal to or more than a certain value (significance T), the television receiver 200 does not need to reproduce the replacement component instead of the default component. The television receiver 200 may record information indicating the significance T, on the basis of a setting operation performed by a user.

When the data broadcasting processor 230 receives an event message in S4, the data broadcasting processor 230 may specify a default component having the same ID as the ID included in the replacement component in the event message.

The data broadcasting processor 230 may refer to information included in the specified default component. Thus, the data broadcasting processor 230 may check the significance of the default component, and may determine whether or not the significance is equal to or more than T. Only when the data broadcasting processor 230 determines that the significance is less than T, the data broadcasting processor 230 may perform the processes in S5 and its subsequent steps.

(Sixth Additional Matter)

The broadcasting device 100 may deliver N event messages (N: plural) during the broadcast time of a program. Each of the N event messages may have reproduction period information indicating the same reproduction period.

In this case, each of the N event messages may include information indicating a reproduction priority of the replacement component included in the event message.

For each of the N event messages, the television receiver 200 may reproduce the replacement component included in the event message, during the reproduction period (a period of Tₑ−Tₛ).

Specifically, when the reproduction start time indicated by the reproduction period information comes, the television receiver 200 may reproduce a replacement component of the highest reproduction priority, instead of the default component having the same ID as the ID included in the replacement component. After that, every time a time of (Tₑ−Tₛ)/N has elapsed, the television receiver 200 may reproduce a replacement component of the highest reproduction priority among one or more replacement components which have not been reproduced, instead of the default component having the same ID as the ID included in the replacement component.

(Seventh Additional Matter)

During the broadcast time of a program, the broadcasting device 100 may deliver a single event message including N replacement components (N: plural). In this case, the event message may include information indicating the reproduction priority of each replacement component included in the event message.

The television receiver 200 may reproduce the N replacement components in the reproduction period (a period of Tₑ−Tₛ) indicated by the reproduction period information included in the event message, by using the method described in the sixth additional matter.

Alternatively, the reproduction priority assigned to the replacement component included in each event message or the reproduction priority assigned to each of the multiple replacement components included in an event message may be used as information indicating a priority for replacement. That is, for multiple types of television receiver 200 having different throughputs, a television receiver 200 having a high throughput may process the replacement components of reproduction priorities 1 to N (all), and a television receiver 200 having a low throughput may process only replacement components of reproduction priority 1. A television receiver 200 having a moderate throughput may process only replacement components of reproduction priorities 1, 2, and 3.

(Eighth Additional Matter)

The reproduction period information includes item “start” indicating the start time of a reproduction period, and item “end” indicating the end time of the reproduction period. One or both of item “start” (or the value of item “start”) and item “end” (or the value of item “end”) may be omitted.

When only item “start” (or the value of item “start”) is omitted, the television receiver 200 may regard the time point at which the event message is received, as the start time of the reproduction period.

When only item “end” (or the value of item “end”) is omitted, the television receiver 200 may regard the end time of the program that is being reproduced at the time point at which the event message is received, as the end time of the reproduction period.

When both of them are omitted, the television receiver 200 may regard the period from the time point at which the event message is received to the end time of the program, as the reproduction period. In the case where item “start” (or the value of item “start”) is omitted and where the value of item “end” is equal to ‘0’, the television receiver 200 may regard a very short given period starting from the time point at which the event message is received, as the reproduction period. That is, the state in which item “start” (or the value of item “start”) is omitted and in which the end of item “end” is equal to ‘0’ means that the event for the event message fires immediately and ends immediately.

(Ninth Additional Matter)

An event message including reproduction period information in which only item “start” (or the value of item “start”) is omitted may include information indicating whether or not permission to “reproduce the replacement component included in the event message when carousel data has not been received at the time point at which the event message is received” is to be given.

Before reception of carousel data, when the television receiver 200 receives an event message including information indicating the permission to perform such reproduction, the television receiver 200 may reproduce data content as follows.

That is, during the period from reception of the event message to reception of carousel data, the television receiver 200 may reproduce only the replacement component (an application and data used in presentation of the data broadcasting screen) included in the event message.

During the period from reception of carousel data to end of the reproduction period, the television receiver 200 may reproduce the replacement component and the components (excluding a component having the same ID as the ID included in the replacement component) included in the carousel data.

In contrast, before reception of carousel data, when the television receiver 200 receives an event message including information indicating that no permission to perform such reproduction is given, the television receiver 200 may reproduce data content as described below. That is, during the period from reception of the event message to reception of carousel data, the television receiver 200 does not need to reproduce data content. During the period from reception of carousel data to end of the reproduction period, the television receiver 200 may reproduce the replacement component and the components (excluding a component having the same ID as the ID included in the replacement component) included in the carousel data.

### Second Embodiment

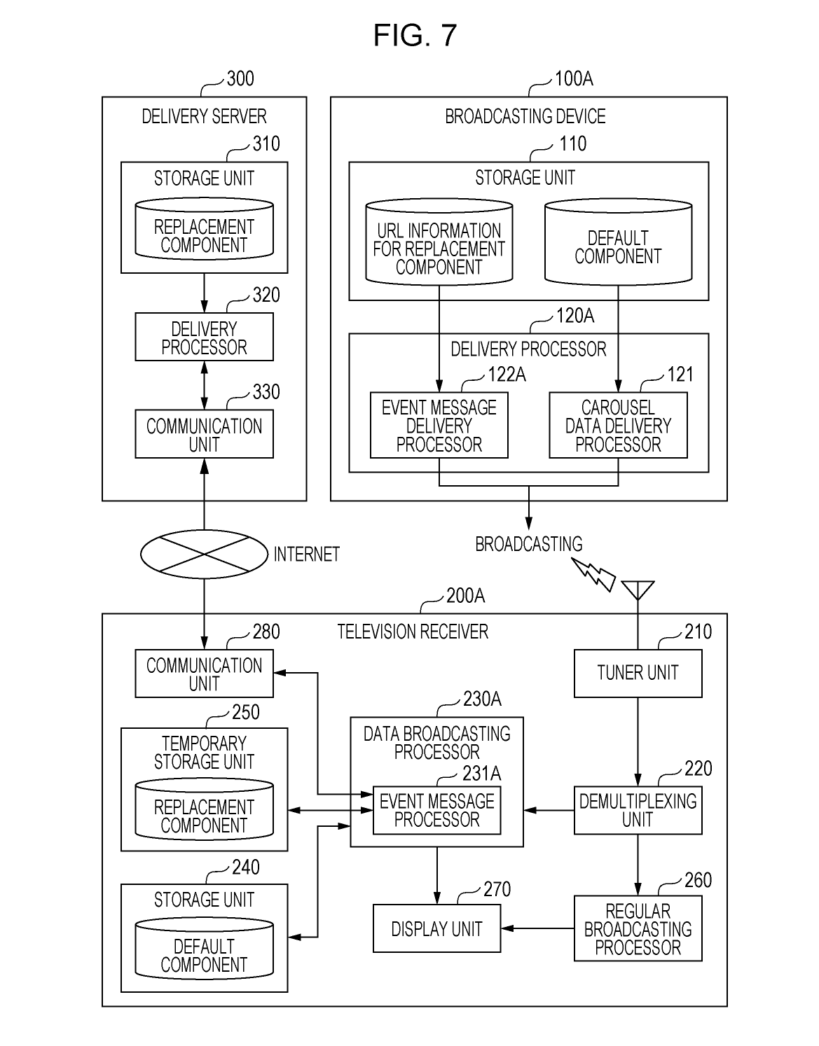

A broadcasting device, a server, and a television receiver included in a system according to another embodiment of the present invention will be described with reference to FIGS. 7 to 9. For convenience of description, component parts having the same functions as those of component parts described in the first embodiment are designated with the same reference characters, and will not be described.

(Overview and Configuration of the Broadcasting Device, the Server, and the Television Receiver)

The overview and configuration of the broadcasting device, the server, and the television receiver will be described with reference to FIG. 7. FIG. 7 is a block diagram illustrating the configuration of principal parts of the broadcasting device, the server, and the television receiver.

A broadcasting device 100A is a similar broadcasting device to the broadcasting device 100 except that, instead of an event message M including a replacement component and reproduction period information indicating a period during which the replacement component is to be reproduced, an event message M′ including the reproduction period information and URL information indicating an acquisition target from which a replacement component is acquired is delivered as a predefined event message.

A television receiver 200A is a similar television receiver to the television receiver 200 except that, instead of extracting a replacement component from an event message M, the television receiver 200A refers to URL information included in an event message M′ so as to obtain a replacement component from a server 300.

The server 300 is a server that delivers the requested replacement component to a television receiver 200A′ in response to a request for a replacement component from the television receiver 200A′ (that is, nonperiodically).

As illustrated in FIG. 7, the broadcasting device 100 includes the storage unit 110 and a delivery processor 120A.

The delivery processor 120A is a processor that delivers a digital broadcast signal by multiplexing video content, audio content, subtitles content, and data content.

The delivery processor 120A functions as the carousel data delivery processor 121 and an event message delivery processor 122A.

Similarly to FIG. 1, the regular-broadcasting delivery processor and the multiplexing unit are not particularly illustrated also in FIG. 7.

The event message delivery processor 122A nonperiodically delivers an event message including the URL information and the reproduction period information described above. The URL information and the reproduction period information are included in the private data area of an event message M′.

As illustrated in FIG. 7, the television receiver 200A includes the tuner unit 210, the demultiplexing unit 220, a data broadcasting processor 230A, the storage unit 240, the temporary storage unit 250, the regular broadcasting processor 260, and the display unit 270.

The data broadcasting processor 230A is a processor that performs processing for presenting data content. The data broadcasting processor 230A performs similar processes to those of the data broadcasting processor 230 except that the data broadcasting processor 230A functions, not as the event message processor 231, as an event message processor 231A.

When the event message processor 231A obtains an event message M′ including the URL information and the reproduction period information described above, the event message processor 231A requests a replacement component specified from the URL information, from a delivery source (server 300A) from which the replacement component is delivered.

When the event message processor 231A obtains the replacement component, the event message processor 231A records the obtained replacement component in the temporary storage unit 250 until the reproduction period indicated by the reproduction period information ends.

When the reproduction period starts, the event message processor 231A deletes one of the default components from the screen. The event message processor 231A displays the replacement component at the position at which the default component has been displayed, over the reproduction period. Instead of deleting a default component from the screen, the event message processor 231A may delete the default component apparently by displaying the replacement component at the display position of the default component so that the replacement component covers the default component.

As illustrated in FIG. 7, the server 300 includes a storage unit 310, a delivery processor 320, and a communication unit 330.

The storage unit 310 is a recording medium in which replacement components are recorded.

The delivery processor 320 delivers a replacement component requested from the television receiver 200A, through the communication unit 330 to the television receiver 200A. The delivery processor 320 may be implemented by using a CPU.

The communication unit 330 is a communication interface compatible with IP communication.

(Operations of the Television Receiver 200A)

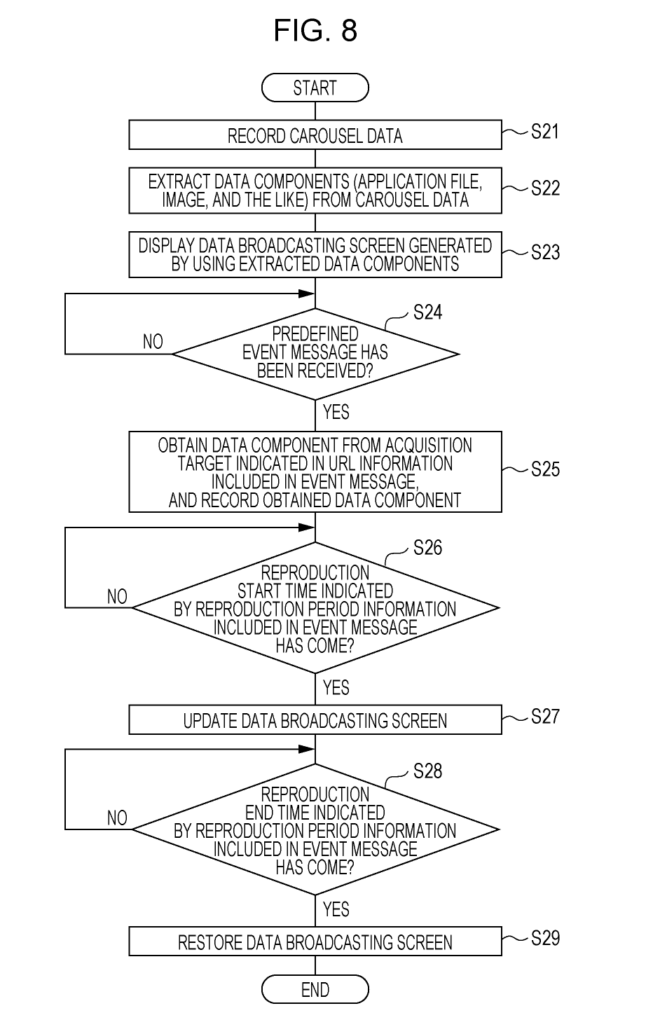

Operations related to reproduction of data content which is performed by the television receiver 200A will be described with reference to FIGS. 8 and 9. FIG. 8 is a flowchart of the operations. FIG. 9 is a conceptual diagram illustrating an exemplary operation related to reproduction of data content which is performed by the television receiver 200A.

When a channel selection operation is completed, the television receiver 200A receives carousel data along with video data, audio data, and subtitles data which constitute a program broadcasted by the broadcasting device 100A. The demultiplexing unit 220 supplies the regular broadcasting processor 260 with the video data, the audio data, and the subtitles data which constitute the program, and supplies the data broadcasting processor 230A with the carousel data.

As illustrated in FIG. 8, the data broadcasting processor 230A performs the processes from S21 to S24 which are similar to those from S1 to S4 described in the first embodiment.

If the data broadcasting processor 230A receives a predefined event message M′ (YES in S24), the event message processor 231A refers to the URL information from the predefined event message M′, and obtains a replacement component from a delivery source (server 300A) from which the replacement component is delivered and which is specified from the URL information. Then, the event message processor 231A records the obtained replacement component in the temporary storage unit 250 (S25). The replacement component includes the ID of a default component that is to be replaced with the replacement component.

After S25, the data broadcasting processor 230A performs the processes from S26 to S29 which are similar to those from S21 to S24 described in the first embodiment.

### Third Embodiment

A system according to yet another embodiment of the present invention will be briefly described below.

The system according to the present embodiment is different from the system according to the first embodiment only in the points described below.

That is, a broadcasting device delivers an event message including the reproduction period information and multiple replacement components that are different from each other. Each of the multiple replacement components includes a priority parameter indicating the use priority of the replacement component and information about which genre the information described by the replacement component belongs to.

A television receiver holds a preference parameter indicating the types of genres for which a user has preference. For example, the television receiver may generate a preference parameter on the basis of a history indicating which programs a user has viewed. The television receiver may record the generated preference parameter in the storage unit or may record, in the storage unit, a preference parameter that is set on the basis of a setting operation performed by the user.

Basically, similarly to the television 200 according to the first embodiment, the television receiver performs operations according to the flowchart in FIG. 2. However, the process of updating the data broadcasting screen in S7 is slightly different from the process performed by the television 200. The update process in S7 performed by the television receiver according to the present embodiment will be specifically described below.

In S7, for each of all or some of the multiple replacement components, the data broadcasting processor of the television receiver according to the present embodiment performs process A and process B described below. (Process A) Among replacement components that have not been selected yet from the multiple replacement components, a replacement component of the highest use priority is selected. (Process B) The priority parameter included in the replacement component selected in process A is compared with the preference parameter so that it is determined whether or not the selected replacement component belongs to a genre for which the user has preference.

If, in process B, it is determined that the replacement component selected in process A does not belong to any genre for which the user has preference, the data broadcasting processor performs process A again. In contrast, if it is determined that the replacement component selected in process A belongs to a genre for which the user has preference, the data broadcasting processor performs the following process.

That is, in S7, the data broadcasting processor specifies the default component having the same ID as the ID included in the latest selected replacement component, and starts reproduction of the replacement component so that the user may view the replacement component instead of the specified default component.

### Fourth Embodiment

A system according to yet another embodiment of the present invention will be described briefly.

The system according to the present embodiment is different from the system according to the second embodiment only in the points described below.

That is, a broadcasting device delivers an event message including the URL information indicating the acquisition target from which a replacement component is acquired, the reproduction period information, and information (viewing condition information) indicating that only paying members of a certain service provided by the broadcasting station have permission to view the replacement component.

The storage unit of a server holds a member information table in which, in association with each member, the member ID of the member and information indicating the type of the member, a paying member or a nonpaying member, are recorded.

The storage unit of a television receiver holds the member IDs of the members (the users of the television receiver) for the certain service.

Basically, similarly to the television receiver 200A according to the second embodiment, the television receiver performs operations according to the flowchart in FIG. 8. However, the television receiver is different from the television receiver 200A in that, after S24, a step described below is performed.

That is, in the step, the data broadcasting processor of the television receiver according to the present embodiment determines whether or not an event message includes the above-described viewing condition information. If the data broadcasting processor determines that the event message does not include the viewing condition information, the process proceeds to S25.

In contrast, if the data broadcasting processor determines that the event message includes the viewing condition information, the data broadcasting processor transmits, to the server, request data for requesting an answer about whether or not the user of the television receiver is a paying member of the certain service. The request data includes the member ID of the user of the television receiver.

When the delivery processor of the server receives the request data, the delivery processor refers to the member information table so as to determine whether or not the member (that is, the user of the television receiver) corresponding to the member ID included in the request data is a paying member. The delivery processor transmits information about the determination result to the television receiver as a response to the request from the television.

Only when the data broadcasting processor of the television receiver receives a determination result indicating that the user of the television receiver is a paying member, the process proceeds to S25.

(Modified Example of Fourth Embodiment)

The viewing condition information may be information indicating that, among the members of a certain service provided by the broadcasting station, only members having acquired a certain number of points or more (or a coupon) have permission to view the replacement component.

In this case, the server may hold a member information table in which the member ID of each member and information about the number of points (coupon) acquired by the member are recorded in association with the member.

When the data broadcasting processor determines that an event message includes the above-described viewing condition information, the data broadcasting processor may transmit, to the server, request data (data including the member ID of the user of the television receiver) for requesting an answer about the number of points acquired by the user of the television receiver.

When the delivery processor of the server receives the request data, the delivery processor transmits, to the television receiver, information indicating the number of points acquired by the user of the television receiver, as a response to the request from the television receiver.

The data broadcasting processor of the television receiver refers to the information received from the server and the viewing condition information so as to determine whether or not the user of the television receiver has a certain number of points or more. Only when the data broadcasting processor determines that the user of the television receiver has a certain number of points or more, the process proceeds to S25.

(Other Additional Matters)

The television receiver according to each embodiment is merely an exemplary reproduction device according to the present invention. That is, another type of television receiver (a cellular phone such as a smartphone, a tablet terminal, a PC, or the like) that has similar characteristics to those of a television receiver described in the specification and that is provided with a function of receiving digital broadcasting is also included in the scope of a reproduction device according to the present invention.

### Exemplary Implementation through Software

The control blocks (especially, the delivery processor (the event message delivery processor) and the data broadcasting processor (the event message processor)) for the broadcasting devices and the television receivers may be implemented by using logic circuits (hardware) formed as integrated circuits (IC chips) or the like, or may be implemented through software by using CPUs (Central Processing Units).

In the latter case, each of the broadcasting devices and the television receivers includes a CPU that executes instructions in programs which are software for implementing the functions, a ROM (Read Only Memory) or a storage device (referred to as a “recording medium”) in which the programs and various data are recorded so as to be computer (or CPU) readable, and a RAM (Random Access Memory) on which the programs are loaded. The computer (or the CPU) reads the programs from the recording medium for execution. Thus, the object of the present invention is achieved. As the recording medium, a “non-transitory physical medium”, for example, a tape, a disk, a card, a semiconductor memory, or a programmable logic circuit, may be used. The programs may be supplied to the computer through any transmission medium (a communication network, broadcast waves, or the like) through which the programs may be transmitted. The present invention may be implemented in the form in which the programs are embodied through electronic transmission and in which a data signal is embedded in a carrier wave.

### Conclusion

A reproduction device (the television receiver 200, 200A) according to a first aspect of the present invention includes an acquisition processor (the demultiplexing unit 220, the data broadcasting processor 230, 230A) and a reproduction processor (the data broadcasting processor 230, 230A). The acquisition processor acquires first data content (a default component), second data content (a replacement component), and information (reproduction period information). The first data content is delivered periodically by broadcasting. The second data content is delivered nonperiodically by broadcasting or communication. The information is delivered nonperiodically by broadcasting. The reproduction processor reproduces the first data content. The information indicates a reproduction period during which the second data content is to be reproduced. In the case where the acquisition processor acquires the information and the second data content, the reproduction processor reproduces the second data content during the reproduction period in such a manner that a user is capable of recognizing the second data content instead of the first data content.

According to the above-described configuration, viewers who view, at the time point of delivery of the information, a program of a broadcasting station delivering the first data content and who also view the program during the reproduction period (certain viewers who continue viewing a program over a certain length of time) may view the second data content (for example, particular content of higher value than that of the first data content) instead of viewing the first data content.

In contrast, viewers other than the certain viewers described above may view the first data content, but not the second data content.

Therefore, the reproduction device has an effect that certain viewers who continue viewing a program over a certain length of time may obtain particular information of higher value.

In the reproduction device (the television receiver 200) according to a second aspect of the present invention, in the first aspect, the acquisition processor (the demultiplexing unit 220, the data broadcasting processor 230) acquires data (an event message M). The data is delivered nonperiodically by broadcasting and includes the information and the second data content.

According to the above-described configuration, manufacturers of the reproduction device do not need to prepare a communication module in order to manufacture the reproduction device. In addition, to obtain particular information of higher value, users of the reproduction device do not need to prepare an adequate communication network environment.

Therefore, the reproduction device may have an additional advantage that the reproduction device may be manufactured at a low cost and an additional advantage that the reproduction device does not request a user to have knowledge and efforts which are necessary for preparing an adequate network environment.

In the reproduction device (the television receiver 200A) according to a third aspect of the present invention, in the first aspect, the acquisition processor (the demultiplexing unit 220, the data broadcasting processor 230A) acquires data (an event message M′). The data is delivered nonperiodically by broadcasting. The data includes information indicating the reproduction period and information indicating an acquisition target from which the second data content is acquired through communication. In the case where the acquisition processor (the data broadcasting processor 230A) acquires the information indicating the acquisition target, the acquisition processor acquires the second data content from the acquisition target through communication.

According to the above-described configuration, users of the reproduction device may obtain particular information of higher value as long as an adequate communication network environment is prepared.

Therefore, the reproduction device prompts users of the reproduction device (users who want to obtain the particular information) to connect the reproduction device to a communication network. That is, the reproduction device may have an additional advantage that users are given an opportunity of enjoying benefits of other various services using both broadcast and communication.

A delivery device (the broadcasting device 100, 100A) according to a fourth aspect of the present invention includes a first delivery processor (the carousel data delivery processor 121) and a second delivery processor (the event message delivery processor 122, 122A). The first delivery processor delivers first data content periodically by broadcasting. The second delivery processor delivers information nonperiodically by broadcasting. The information indicates a reproduction period during which second data content is to be reproduced by a reproduction device in such a manner that a user is capable of recognizing the second data content instead of the first data content.

According to the above-described configuration, the delivery device has an effect that certain viewers who are users of the reproduction device according to the first aspect and who continue viewing a program over a certain length of time may obtain particular information of higher value.

A reproduction method for a reproduction device according to a fifth aspect includes an acquisition step and a first reproduction step. In the acquisition step, first data content, second data content, and information are acquired. The first data content is delivered periodically by broadcasting. The second data content is delivered nonperiodically by broadcasting or communication. The information is delivered nonperiodically by broadcasting. In the first reproduction step, the first data content is reproduced. The information indicates a reproduction period during which the second data content is to be reproduced. A second reproduction step is included as a reproduction step performed instead of the first reproduction step in the reproduction period in the case where the information and the second data content are acquired in the acquisition step. The second reproduction step is a step of reproducing the second data content in such a manner that a user is capable of recognizing the second data content instead of the first data content.

According to the above-described configuration, the reproduction method has a similar effect to that of the reproduction device according to the first aspect.

A delivery method for a delivery device according to a sixth aspect of the present invention includes a first delivery step and a second delivery step. In the first delivery step, first data content is delivered periodically by broadcasting. In the second delivery step, information is delivered nonperiodically by broadcasting. The information indicates a reproduction period during which second data content is to be reproduced by a reproduction device in such a manner that a user is capable of recognizing the second data content instead of the first data content.

According to the above-described configuration, the delivery method has a similar effect to the delivery device according to the fourth aspect.

The reproduction device according to each aspect of the present invention may be implemented by using a computer. In this case, a program and a computer-readable recording medium in which the program is recorded are also encompassed in the present invention. The program causes the computer to operate as the units (software components) included in the reproduction device. Thus, the reproduction device may be implemented by using the computer.

Similarly, the delivery device according to the fourth aspect may be implemented by using a computer. In this case, a program and a computer-readable recording medium in which the program is recorded are also encompassed in the present invention. The program causes the computer to operate as the units (software components) included in the delivery device. Thus, the delivery device may be implemented by using the computer.

The present invention is not limited to the above-described embodiments. Various changes may be made in the scope indicated by the claims. An embodiment obtained by combining, together, technical means disclosed in different embodiments appropriately is also encompassed in the technical scope of the present invention. Further, a new technical characteristic may be obtained by combining, together, technical means disclosed in each embodiment.

### INDUSTRIAL APPLICABILITY

The present invention is an invention which may be preferably used by providers of a data broadcasting service and a service corresponding to the data broadcasting service or may be preferably used by manufacturers of a reproduction device corresponding to such a service.

### REFERENCE SIGNS LIST

100 broadcasting device (delivery device)

120 delivery processor

121 carousel data delivery processor (first delivery processor)

122 event message delivery processor (second delivery processor)

200 television receiver (reproduction device)

220 demultiplexing unit (acquisition processor)

230 data broadcasting processor (acquisition processor, reproduction processor)

1. A reproduction device comprising:
an acquisition processor that acquires first data content, second data content, and information, the first data content being delivered periodically by broadcasting, the second data content being delivered nonperiodically by broadcasting or communication, the information being delivered nonperiodically by broadcasting; and
a reproduction processor that reproduces the first data content,
wherein the information indicates a reproduction period during which the second data content is to be reproduced, and wherein, in a case where the acquisition processor acquires the information and the second data content, the reproduction processor reproduces the second data content during the reproduction period in such a manner that a user is capable of recognizing the second data content instead of the first data content.

2. The reproduction device according to claim 1,
wherein the acquisition processor acquires data, the data being delivered nonperiodically by broadcasting and including the information and the second data content.

3. The reproduction device according to claim 1,
wherein the acquisition processor acquires data, the data being delivered nonperiodically by broadcasting, the data including information indicating the reproduction period and information indicating an acquisition target from which the second data content is acquired through communication, and
wherein, in a case where the acquisition processor acquires the information indicating the acquisition target, the acquisition processor acquires the second data content from the acquisition target through communication.

4. A delivery device comprising:
a first delivery processor that delivers first data content periodically by broadcasting; and
a second delivery processor that delivers information nonperiodically by broadcasting, the information indicating a reproduction period during which second data content is to be reproduced by a reproduction device in such a manner that a user is capable of recognizing the second data content instead of the first data content.

5. A reproduction method for a reproduction device, the method comprising:
an acquisition step of acquiring first data content, second data content, and information, the first data content being delivered periodically by broadcasting, the second data content being delivered nonperiodically by broadcasting or communication, the information being delivered nonperiodically by broadcasting; and
a first reproduction step of reproducing the first data content,
wherein the information indicates a reproduction period during which the second data content is to be reproduced, and
wherein a second reproduction step is included as a reproduction step performed instead of the first reproduction step in the reproduction period in a case where the information and the second data content are acquired in the acquisition step, the second reproduction step being a step of reproducing the second data content in such a manner that a user is capable of recognizing the second data content instead of the first data content.

6. (canceled)
